(19) United States
(12) Patent Application Publication
(10) Pub. No.: US 2019/0281801 A1
(43) Pub. Date: Sep. 19, 2019

(54) FISH RETRIEVAL ASSEMBLY

(71) Applicant: Kelly Powers, Lyman, WY (US)

(72) Inventor: Kelly Powers, Lyman, WY (US)

(21) Appl. No.: 15/923,130

(22) Filed: Mar. 16, 2018

(51) Int. Cl. A01K 77/00; A01K 97/01

(52) U.S. Cl. CPC A01K 77/00; B25G 3/38; A01K 97/01

(57) ABSTRACT

A fish retrieval assembly for lifting a fish out of an ice fishing hole includes a handle for gripping. The handle is elongated such that the handle is extendable downwardly through the ice fishing hole. A scoop is pivotally coupled to the handle and the scoop is positionable in a first position having the scoop being oriented co-linear with the handle. Thus, the scoop may be extended through the ice fishing hole without closing off the ice fishing hole. The scoop is positionable in a second position having the scoop being oriented perpendicular to the handle for lifting a fish upwardly through the ice fishing hole. A trigger is movably coupled between the handle and the scoop to urge the scoop between the first position and the second position.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to retrieval devices and more particularly pertains to a new retrieval device for lifting a fish out of an ice fishing hole.

### BRIEF SUMMARY OF THE INVENTION

An embodiment of the disclosure meets the needs presented above by generally comprising a handle for gripping. The handle is elongated such that the handle is extendable downwardly through an ice fishing hole. A scoop is pivotally coupled to the handle and the scoop is positionable in a first position having the scoop being oriented co-linear with the handle. Thus, the scoop may be extended through the ice fishing hole without closing off the ice fishing hole. The scoop is positionable in a second position having the scoop being oriented perpendicular to the handle for lifting a fish upwardly through the ice fishing hole. A trigger is movably coupled between the handle and the scoop to urge the scoop between the first position and the second position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fish retrieval assembly according to an embodiment of the disclosure.

FIG. 2 is a front view of an embodiment of the disclosure.

FIG. 3 is a right side view of an embodiment of the disclosure showing a scoop moving between a first position and a second position.

FIG. 4 is a top perspective view of a lever and a handle of an embodiment of the disclosure.

FIG. 5 is a perspective in-use view of an embodiment of the disclosure being lowered into an ice fishing hole.

FIG. 6 is a perspective in-use view of an embodiment of the disclosure being lifted in an ice fishing hole.

### DETAILED DESCRIPTION OF THE INVENTION

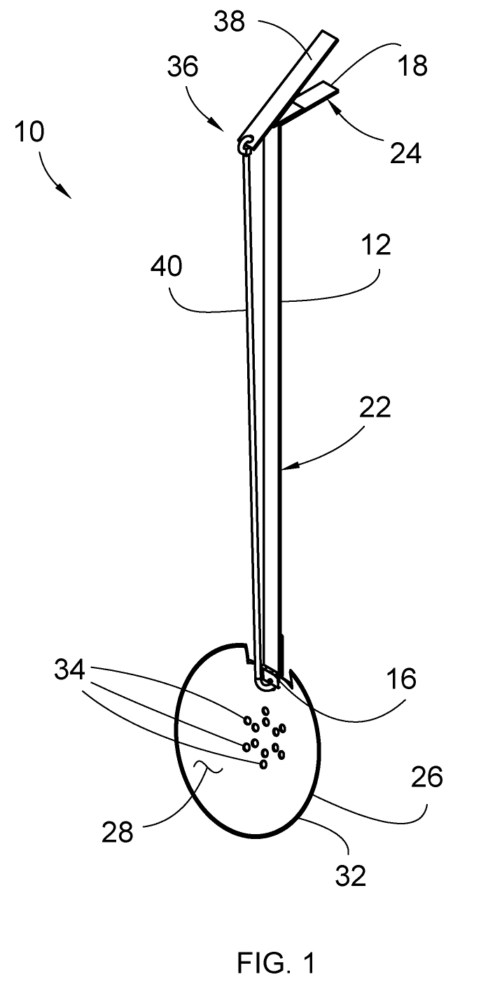

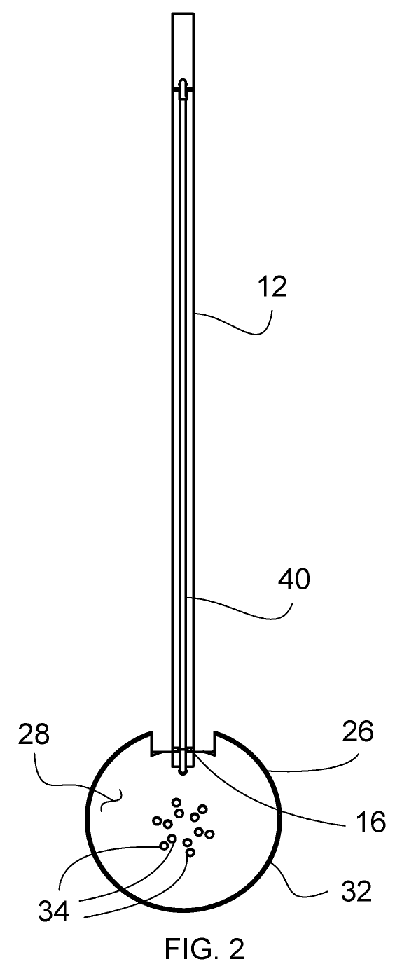

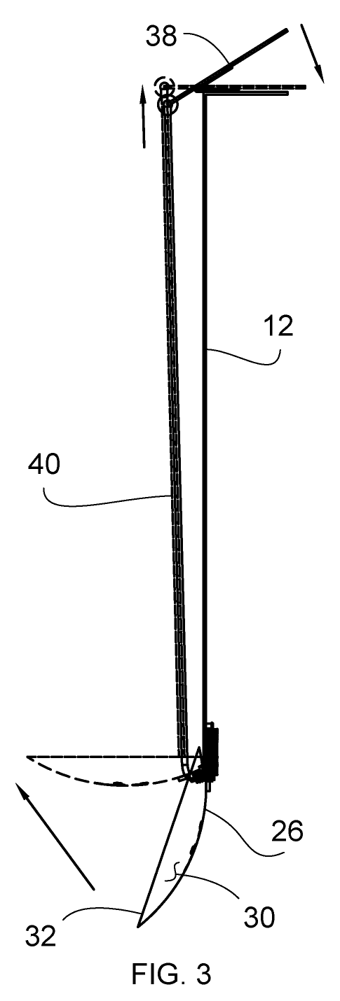

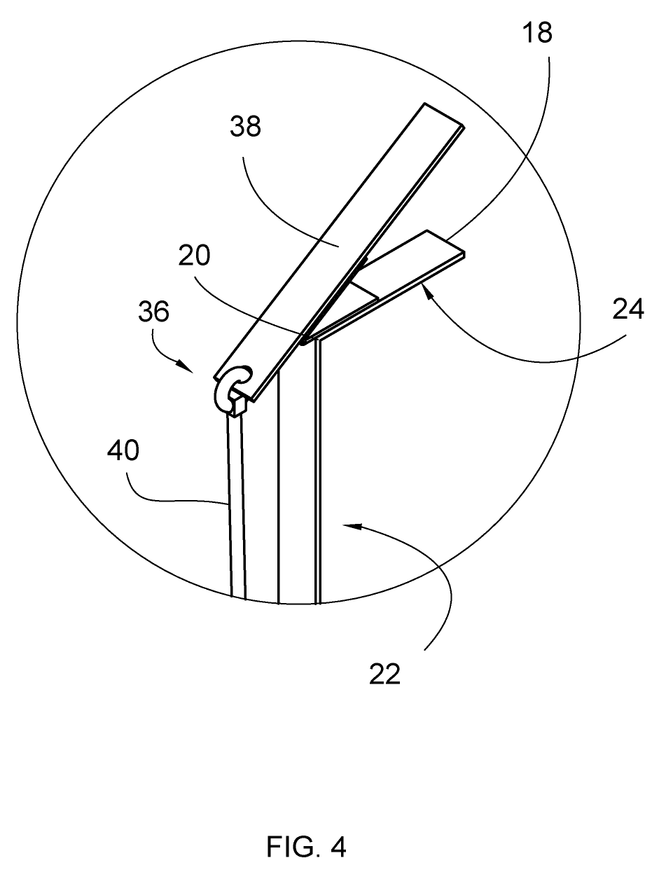

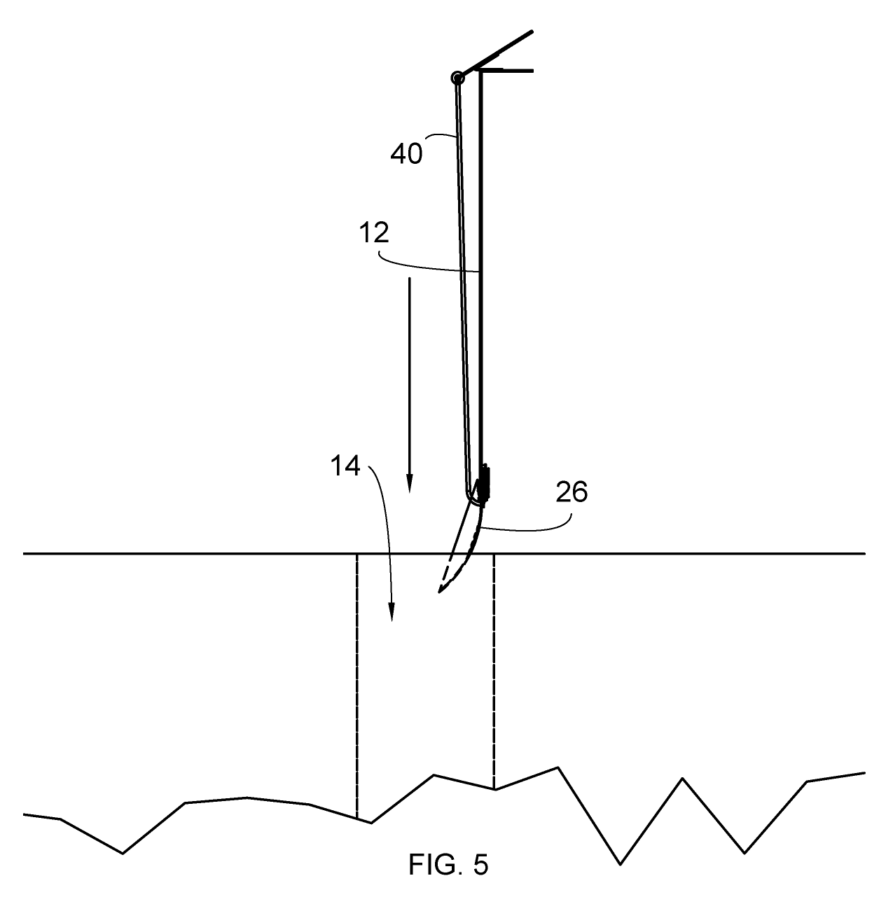

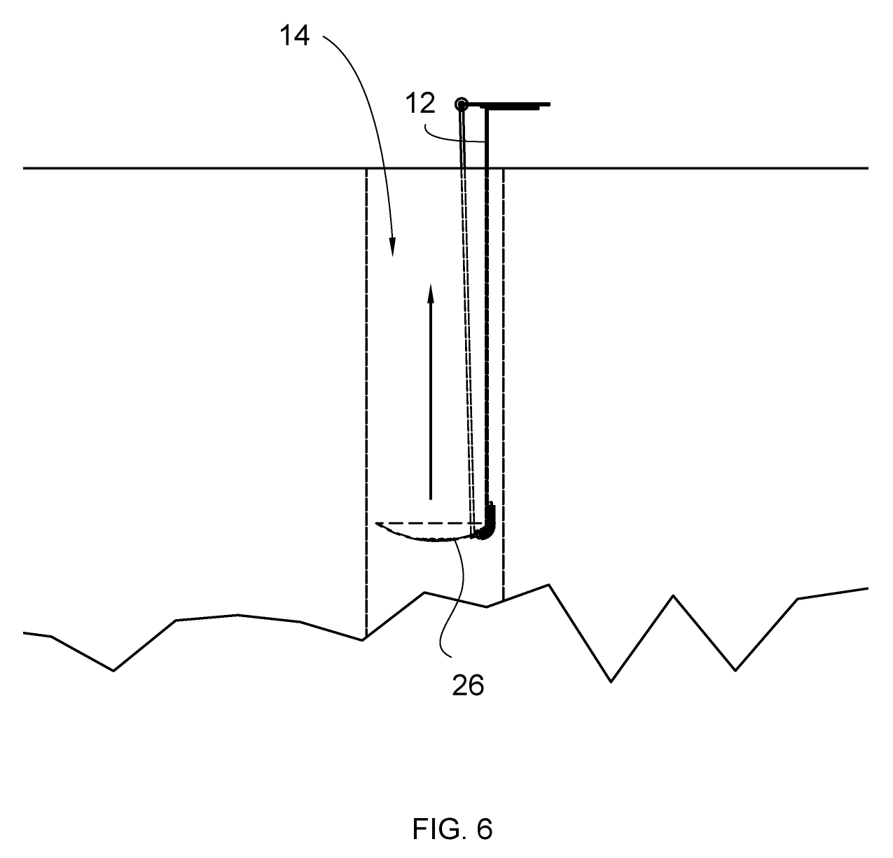

With reference now to the drawings, and in particular to FIGS. 1 through 6 thereof, a new retrieval device embodying the principles and concepts of an embodiment of the disclosure and generally designated by the reference numeral 10 will be described.

As best illustrated in FIGS. 1 through 6, the fish retrieval assembly 10 generally comprises a handle 12 for gripping. The handle 12 is elongated such that the handle 12 is extendable downwardly through an ice fishing hole 14. The ice fishing hole 14 may have a diameter ranging between approximately 6.0 inches and 12.0 inches that corresponds to the diameter of an ice fishing auger. The handle 12 has a first end 16 and a second end 18, the handle 12 is elongated between the first end 16 and the second end 18. Moreover, the handle 12 has a bend 20 thereon to define a first portion 22 of the handle 12 forming an angle with respect to a second portion 24 of the handle 12. The bend 20 is positioned closer to the second end 18 of the handle 12 than the first end 16 of the handle 12 such that the first portion 22 of the handle 12 has a minimum length of at approximately 60.0 cm.

A scoop 26 is provided and the scoop 26 is pivotally coupled to the handle 12. The scoop 26 is positionable in a first position having the scoop 26 being oriented co-linear with the handle 12. In this way the scoop 26 and the handle 12 may be extended through the ice fishing hole 14 without closing off the ice fishing hole 14. The scoop 26 is positionable in a second position having the scoop 26 being oriented perpendicular to the handle 12. Thus, the scoop 26 may close off the ice fishing hole 14 for lifting a fish upwardly into the ice fishing hole 14. In this way the fish may be accessed in the ice fishing hole 14 by a fisherman without the risk of losing the fish.

The scoop 26 has a first surface 28, a second surface 30 and a peripheral edge 32 extending therebetween. The peripheral edge 32 is continuous such that the scoop 26 has a disk shape and the scoop 26 may have a diameter of ranging between approximately 6.0 inches and 12.0 inches. Thus, the scoop 26 may close off the ice fishing hole 14 when the scoop 26 is positioned in the second position. The first surface 28 is concavely arcuate with respect to the peripheral edge 32 such that the scoop 26 forms a bowl. The peripheral edge 32 is pivotally coupled to the first end 16 of the handle 12 and the scoop 26 has a plurality of apertures 34 extending through the first surface 28 and the second surface 30 for draining fluid out of the scoop 26.

A trigger 36 is movably coupled between the handle 12 and the scoop 26 to urge the scoop 26 between the first position and the second position. The trigger 36 comprises a lever 38 that is pivotally coupled to the handle 12. The lever 38 is positioned on the bend 20 and the lever 38 is oriented at an angle with the second portion 24 of the handle 12. The lever 38 can be gripped and squeezed downwardly onto the second portion 24 of the handle 12. The trigger includes a cable 40 that is coupled between the lever 38 and the scoop 26 and the cable 40 is urged upwardly along the handle 12 when the lever 38 is squeezed. In this way the cable 40 lifts the scoop 26 into the second position when the lever 38 is squeezed. The cable 40 is urged downwardly along the handle 12 when the lever 38 is released thereby lowering the scoop 26 into the first position. The cable 40 has a plastic coating to inhibit ice from forming on the cable 40 and potentially inhibiting the trigger 36 from properly functioning. Additionally, the scoop 26 is urged by gravity into the first position when the lever 38 is released.

In use, the second portion 24 of the handle 12 is gripped and the scoop 26 is directed downwardly through the ice fishing hole 14 while the scoop 26 is in the first position. The handle 12 is extended a sufficient distance into the ice fishing hole 14 to allow the scoop 26 to be positioned below a fish that has been caught on a fishing line. The lever 38 is squeezed thereby urging the scoop 26 into the second position and the handle 12 is lifted upwardly in the ice fishing hole 14. Thus, the scoop 26 lifts the fish that has been caught on the fishing line upwardly into the ice fishing hole 14 thereby facilitating the fisherman to grab the fish and release the fish from the fishing line. The scoop 26 closes off the ice fishing hole 14 when the scoop 26 is in the second position thereby inhibiting the fish from falling between the scoop 26 and a bounding surface of the ice fishing hole 14. Additionally, the scoop 26 facilitates slush and floating ice to be removed from the ice fishing hole 14 to keep the ice fishing hole 14 from freezing over.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fish retrieval assembly being configured to be extended through an ice fishing hole to retrieve a fish through the ice fishing hole, said assembly comprising:
a handle for gripping, said handle being elongated such that said handle is extendable downwardly through an ice fishing hole without closing off the ice fishing hole;
a scoop being pivotally coupled to said handle, said scoop being positionable in a first position having said scoop being oriented co-linear with said handle for extending said scoop through the ice fishing hole, said scoop being positionable in a second position having said scoop being oriented perpendicular to said handle for lifting a fish upwardly through the ice fishing hole; and
a trigger being movably coupled between said handle and said scoop to urge said scoop between said first position and said second position.

2. The assembly according to claim 1, wherein said handle has a first end and a second end, said handle being elongated between said first end and said second end, said handle having a bend thereon to define a first portion of said handle forming an angle with respect to a second portion of said handle, said bend being positioned closer to said second end of said handle than said first end of said handle.

3. The assembly according to claim 2, wherein said scoop has a first surface, a second surface and a peripheral edge extending therebetween, said peripheral edge being continuous such that said scoop has a disk shape, said first surface being concavely arcuate with respect to said peripheral edge such that said scoop forms a bowl, said peripheral edge being pivotally coupled to said first end of said handle.

4. The assembly according to claim 3, wherein said scoop has a plurality of apertures extending through said first surface and said second surface for draining fluid out of said scoop.

5. The assembly according to claim 3, wherein said trigger comprises a lever being pivotally coupled to said handle, said lever being positioned on said bend, said lever being oriented at an angle with said second portion of said handle.

6. The assembly according to claim 5, further comprising a cable being coupled between said lever and said scoop, said cable being urged upwardly along said handle when said lever is squeezed thereby lifting said scoop into said second position, said cable being urged downwardly along said handle when said lever is released thereby lowering said scoop into said first position.

7. A fish retrieval assembly being configured to be extended through an ice fishing hole to retrieve a fish through the ice fishing hole, said assembly comprising:
a handle for gripping, said handle being elongated such that said handle is extendable downwardly through an ice fishing hole, said handle having a first end and a second end, said handle being elongated between said first end and said second end, said handle having a bend thereon to define a first portion of said handle forming an angle with respect to a second portion of said handle, said bend being positioned closer to said second end of said handle than said first end of said handle;
a scoop being pivotally coupled to said handle, said scoop being positionable in a first position having said scoop being oriented co-linear with said handle for extending said scoop through the ice fishing hole without closing off the ice fishing hole, said scoop being positionable in a second position having said scoop being oriented perpendicular to said handle for lifting a fish upwardly through the ice fishing hole, said scoop having a first surface, a second surface and a peripheral edge extending therebetween, said peripheral edge being continuous such that said scoop has a disk shape, said first surface being concavely arcuate with respect to said peripheral edge such that said scoop forms a bowl, said peripheral edge being pivotally coupled to said first end of said handle, said scoop having a plurality of apertures extending through said first surface and said second surface for draining fluid out of said scoop; and
a trigger being movably coupled between said handle and said scoop to urge said scoop between said first position and said second position, said trigger comprising:
a lever being pivotally coupled to said handle, said lever being positioned on said bend, said lever being oriented at an angle with said second portion of said handle; and
a cable being coupled between said lever and said scoop, said cable being urged upwardly along said handle when said lever is squeezed thereby lifting said scoop into said second position, said cable being urged downwardly along said handle when said lever is released thereby lowering said scoop into said first position.
